(19) United States
(12) Patent Application Publication
(10) Pub. No.: US 2026/0343027 A1
(43) Pub. Date: Oct. 29, 2026

(54) LIMITING SIGNALED MOTION VECTOR SYNTAX FOR TEMPORALLY INTERPOLATED PICTURE VIDEO CODING

(71) Applicant: GOOGLE LLC, Mountain View, CA (US)

(72) Inventors: In Suk Chong, Mountain View, CA (US); Todd Nguyen, Saratoga, CA (US); Joseph Young, Mountain View, CA (US)

(21) Appl. No.: 19/490,303

(22) PCT Filed: Jun. 4, 2024
(86) PCT No.: PCT/US2024/032357

§ 371 Date: Dec. 4, 2025

Related U.S. Application Data
(60) Provisional application No. 63/506,153, filed on Jun. 5, 2023.

(51) Int. Cl. H04N 19/70; H04N 19/172; H04N 19/52; H04N 19/577

(52) U.S. Cl. CPC H04N 19/70; H04N 19/172; H04N 19/52; H04N 19/577

(57) ABSTRACT

The syntax elements signaled for a prediction of a current frame are limited based on the use of the syntax elements for video coding using a generated (e.g., temporally interpolated picture) reference frame. A determination is made to decode a current frame using a generated reference frame generated using a backward reference frame of the current frame and a forward reference frame of the current frame. Syntax elements usable for a prediction of the current frame using the generated reference frame are decoded from a bitstream to which a prediction for the current frame is encoded, in which the syntax elements limit one or more of signaled motion vector resolution values, signaled motion vector predictors, or signaled motion vector class information. The prediction for the current frame is then reconstructed using the generated reference frame and the limited syntax elements.

### BACKGROUND

Digital video streams may represent video using a sequence of frames or still images. Digital video can be used for various applications including, for example, video conferencing, high definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

Disclosed herein are, inter alia, systems and techniques for limiting signaled motion vector syntax for temporally interpolated picture video coding.

A method for limiting signaled motion vector syntax for video coding according to an implementation of this disclosure comprises: determining to decode a current frame using a generated reference frame generated using a backward reference frame of the current frame and a forward reference frame of the current frame; decoding, from a bitstream to which a prediction for the current frame is encoded, syntax elements usable for a prediction of the current frame using the generated reference frame, wherein the syntax elements limit one or more of signaled motion vector resolution values, signaled motion vector predictors, or signaled motion vector class information; and reconstructing the prediction for the current frame using the generated reference frame and the syntax elements.

In some implementations of the method, the syntax elements limit signaled motion vector resolution values for the prediction of the current frame to values less than or equal to 1.

In some implementations of the method, the syntax elements limit a number of signaled motion vector predictors to less than 4.

In some implementations of the method, the syntax elements limit signaled class information for a motion vector to use for the prediction for the current frame to class 0, class 1, or class 2.

In some implementations of the method, the syntax elements represent output of an encoder-side search performed during an encoding of the current frame.

In some implementations of the method, the determination to decode the current frame using the generated reference frame is based on a syntax element associated with the current frame within the bitstream.

In some implementations of the method, the generated reference frame is a temporally interpolated picture reference frame.

A non-transitory computer readable medium according to an implementation of this disclosure has stored thereon an encoded bitstream, wherein the encoded bitstream is configured for decoding by operations for limiting signaled motion vector syntax for video coding, the operations comprising: determining to decode a current frame using a generated reference frame associated with the current frame; decoding, from the encoded bitstream, syntax elements limiting one or more of signaled motion vector resolution values, signaled motion vector predictors, or signaled motion vector class information; and reconstructing a prediction for the current frame using the generated reference frame and the syntax elements.

In some implementations of the non-transitory computer readable medium, the syntax elements limit signaled motion vector resolution values for the prediction of the current frame to values less than or equal to 1.

In some implementations of the non-transitory computer readable medium, the syntax elements limit a number of signaled motion vector predictors to less than 4.

In some implementations of the non-transitory computer readable medium, the syntax elements limit signaled class information for a motion vector to use for the prediction for the current frame to class 0, class 1, or class 2.

In some implementations of the non-transitory computer readable medium, the determination to decode the current frame using the generated reference frame is based on a syntax element associated with the current frame within the encoded bitstream.

In some implementations of the non-transitory computer readable medium, the generated reference frame is a temporally interpolated picture reference frame generated using a backward reference frame of the current frame and a forward reference frame of the current frame.

An apparatus for limiting signaled motion vector syntax for video coding according to an implementation of this disclosure comprises: a memory and a processors configured to execute instructions stored in the memory to: decode, based on a determination to use a generated reference frame for a prediction of a current frame, syntax elements limiting one or more of signaled motion vector resolution values, signaled motion vector predictors, or signaled motion vector class information; and reconstruct the prediction using the generated reference frame and the syntax elements.

In some implementations of the apparatus, the syntax elements limit signaled motion vector resolution values for the prediction of the current frame to values less than or equal to 1.

In some implementations of the apparatus, the syntax elements limit a number of signaled motion vector predictors to less than 4.

In some implementations of the apparatus, the syntax elements limit signaled class information for a motion vector to use for the prediction for the current frame to class 0, class 1, or class 2.

In some implementations of the apparatus, the syntax elements represent output of an encoder-side search performed during an encoding of the current frame.

In some implementations of the apparatus, the determination to decode the current frame using the generated reference frame is based on a syntax element associated with the current frame within a bitstream.

In some implementations of the apparatus, the generated reference frame is a temporally interpolated picture reference frame generated using a backward reference frame of the current frame and a forward reference frame of the current frame.

These and other aspects of this disclosure are disclosed in the following detailed description of the implementations, the appended claims and the accompanying figures.

### BRIEF DESCRIPTION OF THE DRAWINGS

The description herein makes reference to the accompanying drawings described below, wherein like reference numerals refer to like parts throughout the several views.

FIG. 1 is a schematic of an example of a video encoding and decoding system.

FIG. 2 is a block diagram of an example of a computing device that can implement a transmitting station or a receiving station.

FIG. 3 is a diagram of an example of a video stream to be encoded and decoded.

FIG. 4 is a block diagram of an example of an encoder.

FIG. 5 is a block diagram of an example of a decoder.

FIG. 6 is an illustration of examples of portions of a video frame.

FIG. 7 is an illustration of frames used to temporally interpolated picture video coding.

FIG. 8 is an illustration of signaled motion vector syntax elements limited for temporally interpolated picture video coding.

FIG. 9 is a flowchart diagram of an example of a technique for encoding a current frame using temporally interpolated picture video coding with limited signaled motion vector syntax.

FIG. 10 is a flowchart diagram of an example of a technique for decoding a current frame using temporally interpolated picture video coding with limited signaled motion vector syntax.

### DETAILED DESCRIPTION

Video compression schemes may include breaking respective images, or frames, of a video stream into smaller portions, such as blocks, and generating an encoded bitstream by using encoding techniques to limit the information included for respective blocks thereof. The bitstream can be decoded to re-create the source frames from the limited information. A video stream can be compressed (i.e., encoded) by a variety of techniques to reduce bandwidth required to transmit or store the video stream. Similarly, a variety of techniques can be used to decompress (i.e., decode) a compressed video stream from a bitstream, to prepare the video stream for viewing or further processing. Compression of the video stream often exploits spatial and temporal correlation of video signals through spatial and/or motion-compensated prediction. Motion-compensated prediction may also be referred to as inter-prediction. Inter-prediction uses one or more motion vectors to generate a block (also called a prediction block) that resembles a current block to be encoded using previously encoded and decoded pixels. By encoding the motion vector(s), and the difference between the two blocks (i.e., a residual), a decoder receiving the encoded signal can reconstruct the current block by generating the prediction block and adding pixels of the prediction block to the decoded residual block.

Each motion vector used to generate a prediction block in the inter-prediction process refers a reference frame (i.e., a frame other than a current frame which includes the block that is under prediction). Reference frames can be located before or after the current frame in the sequence of the video stream and may be frames that are reconstructed before being used as a reference frame. In particular, a reference frame may be a forward reference frame (i.e., a frame used for forward prediction relative to the sequence) or a backward reference frame (i.e., a frame used for backward prediction relative to the sequence). One or more forward and/or backward reference frames can be used to encode or decode a block. In particular, because many conventional video compression and decompression schemes use a pyramid coding structure to achieve high compression efficiencies, many frames are encoded and decoded using bi-directional prediction, such as using a forward reference frame and a backward reference frame. Bi-directional prediction using forward and backward reference frames has been shown to substantially improve the quality of prediction and thus the overall compression performance for the subject video stream.

One recent approach for bi-directional prediction uses a temporally interpolated picture (TIP) reference frame. A TIP reference frame is a reference frame generated by interpolating reference blocks from a forward reference frame and a backward reference frame (e.g., as the nearest future and past reference frames relative to the current frame). In particular, the coded motion vectors available in the forward and backward reference frames are used to generate a motion field for the current frame, and the motion field is the used to fetch the reference blocks which are used to generate the TIP reference frame. TIP video coding thus refers to an inter-prediction mode whereby a TIP reference frame is used to predict the motion of a current frame. TIP video coding typically involves a relatively small motion vector being applied against the TIP reference frame, which small motion vector is not only cheaper to encode, but also improves prediction detail and quality due to the TIP reference frame leveraging forward and backward reference data. The TIP reference frame is independently generated at each of the encoder and the decoder. In particular, the encoder generates the TIP reference frame using data determined as part of an encoder search process, and the decoder generates the TIP reference frame using bitstream data indicative of that encoder search process. The use of this TIP mode for video coding has shown remarkable coding gain achievements relative to video coding schemes which do not use the TIP mode.

Current approaches for TIP video coding use a number of syntax elements to signal the data used for TIP video coding within a bitstream. In particular, such current approaches use five different sets of syntax elements signaled within a frame header for a given frame, in which: a first set includes, in an example, a one bit syntax element indicating whether or not the TIP mode should be used for the given frame; a second set includes, in an example, a two bit syntax element indicating one of four possible motion vector modes for the motion vector used for a TIP reference frame for the given frame, in which the four possible motion vector modes correspond to NEARMV, GLOBALMV, NEWMV, and MVDNEWMV; a third set includes, in an example, a three bit syntax element indicating one of seven possible motion vector resolutions for the TIP mode prediction, in which the seven possible motion vector resolutions, expressed in units of pixels, correspond to ⅛ pixel, ¼ pixel, ½ pixel, 1 pixel, 2 pixels, 4 pixels, and 8 pixels; a fourth set includes, in an example, a two bit syntax element indicating one of four possible motion vector predictor candidates for the motion vector to use for the TIP reference frame based on the motion vector mode used therefor (although, where the motion vector mode is MVDNEWMV, the two bit syntax element may indicate one of two possible motion vector predictor candidates or the fourth set may include a one bit syntax element used to indicate one of those two possible motion vector predictor candidates; and a fifth set includes, in an example, a syntax element of one or more bits indicating the motion vector difference coding values of class and refinement for the motion vector.

Despite this, many of the possible values which may be signaled in connection with TIP video coding are unnecessary and even irrelevant due to the characteristics of the TIP mode. In particular, because the motion vector used for TIP mode video coding is generally and relatively small compared to motion vectors as may otherwise be used for inter-prediction, many of the values available and signaled under current TIP video coding approaches are not actually usable with TIP video coding. Thus, the coding gains obtained via the use of TIP video coding are nonetheless compromised or inhibited due to the computational cost spent signaling these unnecessary and irrelevant values. Implementations of this disclosure accordingly address problems such as these by limiting signaled motion vector syntax for temporally interpolated picture video coding. In particular, the implementations of this disclosure describe approaches for limiting various sets of syntax elements which may be signaled in connection with TIP video coding according to the usable value range for TIP reference frames. TIP video coding according to the implementations of this disclosure thus achieve coding gains beyond those already realized via current TIP video coding approaches and therefore further improve the video coding process.

While reference is made herein by example to superblocks, macroblocks, blocks, and the like, as are commonly used in video codecs such as VP9, AV1, and the currently in-development AV2, the implementations of this disclosure may be used with other video coding structures. In one particular but non-limiting example, the implementations of this disclosure may be used with coding tree units (CTUs), coding units (CUs), prediction units (Pus), and the like, as are commonly used in video codecs such as H.265, referred to as High-Efficiency Video Coding, and H.266, referred to as Versatile Video Coding. Accordingly, references herein to particular video coding structures such as superblocks, macroblocks, blocks, and the like shall be regarded as expressions of non-limiting example video coding structures with which the implementations of this disclosure may be used.

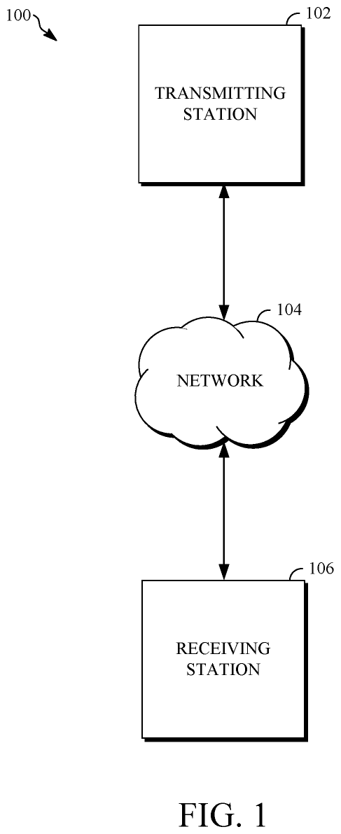

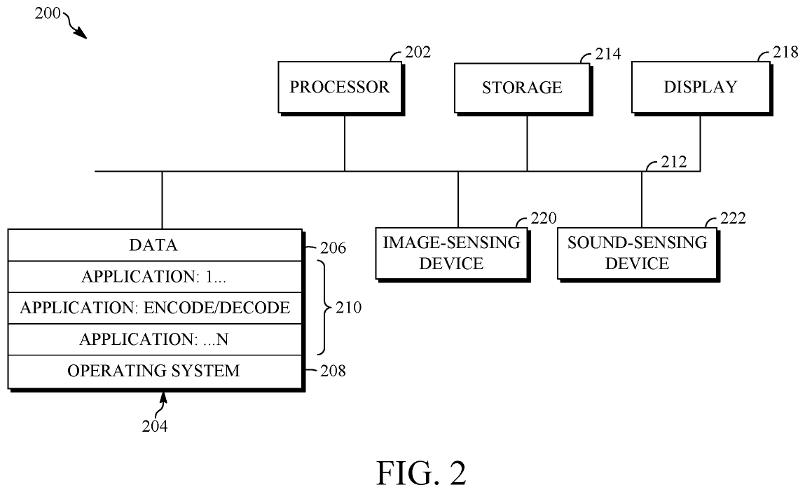

Further details of techniques for limiting signaled motion vector syntax for TIP video coding are described herein with initial reference to a system in which such techniques can be implemented. FIG. 1 is a schematic of an example of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a video streaming protocol based on the Hypertext Transfer Protocol (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

In some implementations, the video encoding and decoding system 100 may instead be used to encode and decode data other than video data. For example, the video encoding and decoding system 100 can be used to process image data. The image data may include a block of data from an image. In such an implementation, the transmitting station 102 may be used to encode the image data and the receiving station 106 may be used to decode the image data.

Alternatively, the receiving station 106 can represent a computing device that stores the encoded image data for later use, such as after receiving the encoded or pre-encoded image data from the transmitting station 102. As a further alternative, the transmitting station 102 can represent a computing device that decodes the image data, such as prior to transmitting the decoded image data to the receiving station 106 for display.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include encoding and/or decoding software that performs, amongst other things, limiting signaled motion vector syntax for temporally interpolated picture video coding as described herein.

The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200.

Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

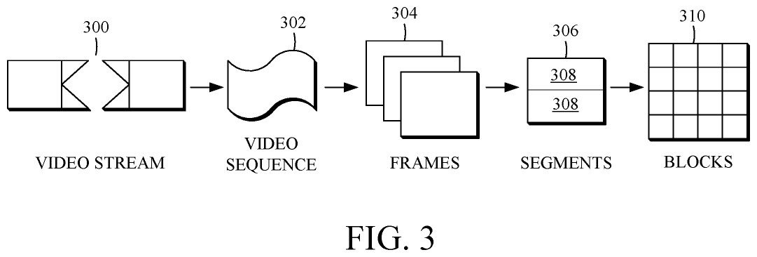

FIG. 3 is a diagram of an example of a video stream 300 to be encoded and decoded. The video stream 300 includes a video sequence 302. At the next level, the video sequence 302 includes a number of adjacent video frames 304. While three frames are depicted as the adjacent frames 304, the video sequence 302 can include any number of adjacent frames 304. The adjacent frames 304 can then be further subdivided into individual video frames, for example, a frame 306.

At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, N×M pixels in the frame 306, in which N and M may refer to the same integer value or to different integer values. The blocks 310 can also be arranged to include data from one or more segments 308 of pixel data. The blocks 310 can be of any suitable size, such as 4×4 pixels, 8×8 pixels, 16×8 pixels, 8×16 pixels, 16×16 pixels, or larger up to a maximum block size, which may be 128×128 pixels or another N×M pixels size.

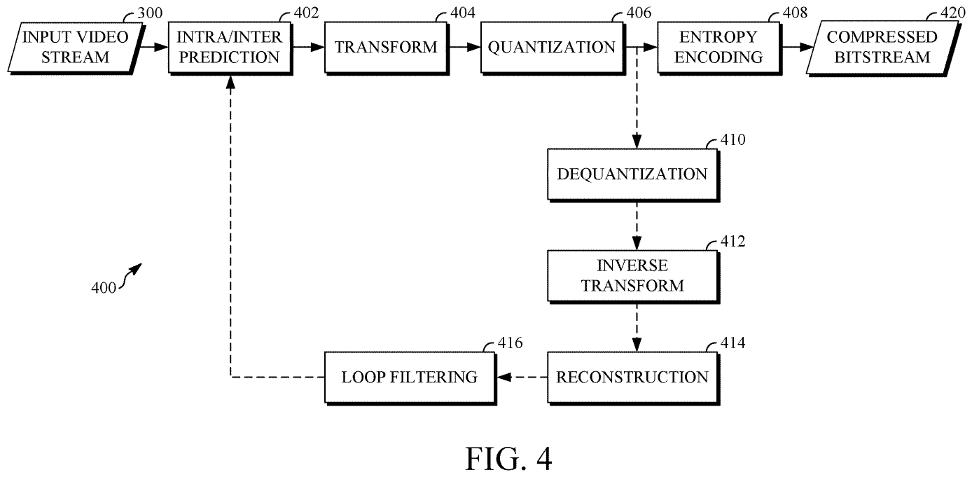

FIG. 4 is a block diagram of an example of an encoder 400. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In some implementations, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

In some cases, the functions performed by the encoder 400 may occur after a filtering of the video stream 300. That is, the video stream 300 may undergo pre-processing according to one or more implementations of this disclosure prior to the encoder 400 receiving the video stream 300. Alternatively, the encoder 400 may itself perform such pre-processing against the video stream 300 prior to proceeding to perform the functions described with respect to FIG. 4, such as prior to the processing of the video stream 300 at the intra/inter prediction stage 402.

When the video stream 300 is presented for encoding after the pre-processing is performed, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding or arithmetic coding. The compressed bitstream 420 can also be referred to as an encoded video stream or encoded video bitstream, and the terms will be used interchangeably herein.

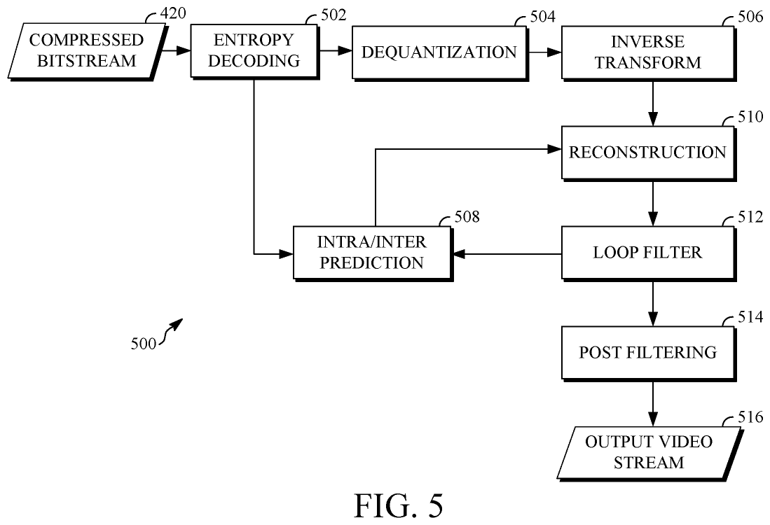

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual).

At the reconstruction stage 414, the prediction block that was predicted at the intra/inter prediction stage 402 can be added to the derivative residual to create a reconstructed block. The loop filtering stage 416 can apply an in-loop filter or other filter to the reconstructed block to reduce distortion such as blocking artifacts. Examples of filters which may be applied at the loop filtering stage 416 include, without limitation, a deblocking filter, a directional enhancement filter, and a loop restoration filter.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of an example of a decoder 500. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106. In some implementations, the decoder 500 is a hardware decoder.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filter stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Examples of filters which may be applied at the loop filtering stage 512 include, without limitation, a deblocking filter, a directional enhancement filter, and a loop restoration filter. Other filtering can be applied to the reconstructed block. In this example, the post filter stage 514 is applied to the reconstructed block to reduce blocking distortion, and the result is output as the output video stream 516. The output video stream 516 can also be referred to as a decoded video stream, and the terms will be used interchangeably herein.

Other variations of the decoder 500 can be used to decode the compressed bitstream 420. In some implementations, the decoder 500 can produce the output video stream 516 without the post filter stage 514 or otherwise omit the post filter stage 514.

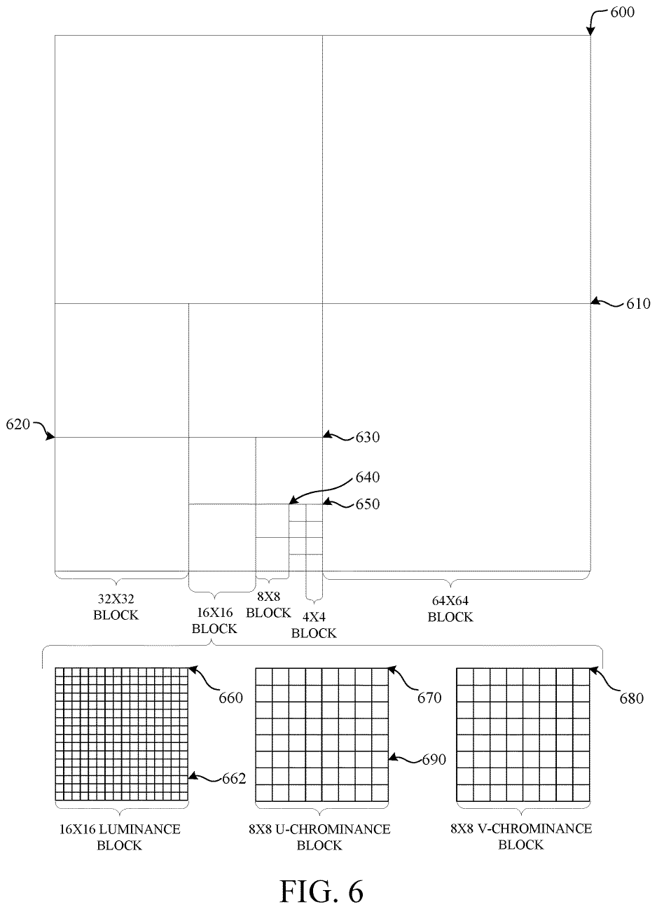

FIG. 6 is an illustration of examples of portions of a video frame 600, which may, for example, be the frame 306 shown in FIG. 3. The video frame 600 includes a number of 64×64 blocks 610, such as four 64×64 blocks 610 in two rows and two columns in a matrix or Cartesian plane, as shown. Each 64×64 block 610 may include up to four 32×32 blocks 620. Each 32×32 block 620 may include up to four 16×16 blocks 630. Each 16×16 block 630 may include up to four 8×8 blocks 640. Each 8×8 block 640 may include up to four 4×4 blocks 950. Each 4×4 block 950 may include 16 pixels, which may be represented in four rows and four columns in each respective block in the Cartesian plane or matrix. In some implementations, the video frame 600 may include blocks larger than 64×64 and/or smaller than 4×4. Subject to features within the video frame 600 and/or other criteria, the video frame 600 may be partitioned into various block arrangements.

The pixels may include information representing an image captured in the video frame 600, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680.

The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used, wherein N and M are different numbers. For example, 32×64 blocks, 64×32 blocks, 16×32 blocks, 32×16 blocks, or any other size blocks may be used. In some implementations, N×2N blocks, 2N×N blocks, or a combination thereof, may be used.

In some implementations, coding the video frame 600 may include ordered block-level coding. Ordered block-level coding may include coding blocks of the video frame 600 in an order, such as raster-scan order, wherein blocks may be identified and processed starting with a block in the upper left corner of the video frame 600, or portion of the video frame 600, and proceeding along rows from left to right and from the top row to the bottom row, identifying each block in turn for processing. For example, the 64×64 block in the top row and left column of the video frame 600 may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block of the video frame 600 may include using quad-tree coding, which may include coding smaller block units within a block in raster-scan order. For example, the 64×64 block shown in the bottom left corner of the portion of the video frame 600 may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, coding the video frame 600 may include encoding the information included in the original version of the image or video frame by, for example, omitting some of the information from that original version of the image or video frame from a corresponding encoded image or encoded video frame. For example, the coding may include reducing spectral redundancy, reducing spatial redundancy, or a combination thereof. Reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of the video frame 600, and using a relatively small amount of information to represent each corresponding chrominance component for the portion of the video frame 600. For example, a portion of the video frame 600 may be represented by a high-resolution luminance component, which may include a 16×16 block of pixels, and by two lower resolution chrominance components, each of which represents the portion of the image as an 8×8 block of pixels. A pixel may indicate a value, for example, a value in the range from 0 to 255, and may be stored or transmitted using, for example, eight bits.

Although this disclosure is described in reference to the YUV color model, another color model may be used. Reducing spatial redundancy may include transforming a block into the frequency domain using, for example, a discrete cosine transform. For example, a unit of an encoder may perform a discrete cosine transform using transform coefficient values based on spatial frequency.

Although described herein with reference to matrix or Cartesian representation of the video frame 600 for clarity, the video frame 600 may be stored, transmitted, processed, or a combination thereof, in a data structure such that pixel values may be efficiently represented for the video frame 600. For example, the video frame 600 may be stored, transmitted, processed, or any combination thereof, in a two-dimensional data structure such as a matrix as shown, or in a one-dimensional data structure, such as a vector array. Furthermore, although described herein as showing a chrominance subsampled image where U and V have half the resolution of Y, the video frame 600 may have different configurations for the color channels thereof. For example, referring still to the YUV color space, full resolution may be used for all color channels of the video frame 600. In another example, a color space other than the YUV color space may be used to represent the resolution of color channels of the video frame 600.

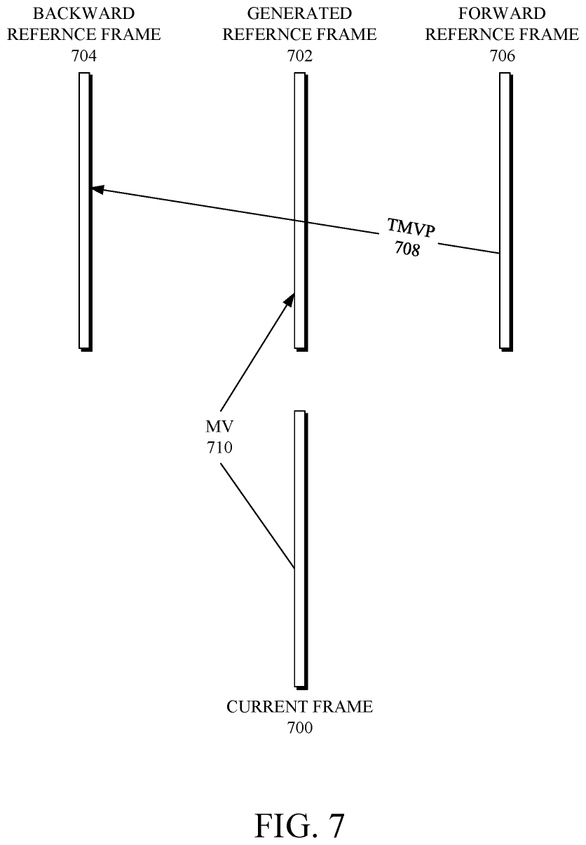

FIG. 7 is an illustration of frames used with TIP video coding. A current frame 700 represents a frame under prediction (e.g., using the TIP mode described herein), for example, during encoding (e.g., at the intra/inter prediction stage 402) or decoding (e.g., at the intra/inter prediction stage 510). A generated reference frame 702, which may, for example, be a TIP reference frame, is generated (e.g., on a streaming basis (i.e., portion by portion)) using a motion field based on a backward reference frame 704 and a forward reference frame 706. For example, where the current frame 700 is denoted as Fᵢ, the backward reference frame 704 can be denoted as Fᵢ₋₁ and the forward reference frame 706 can be denoted at Fᵢ₊₁.

Generally, the backward reference frame 704 and the forward reference frame 706 will be the same distance apart from the current frame 700 in a display order of the video sequence that includes them. However, in some implementations, the backward reference frame 704 and the forward reference frame 706 may be different distances apart from the current frame 700 in the display order. A temporal motion vector predictor 708 represents a motion vector predictor pointing from the backward reference frame 704 to the forward reference frame 706. A motion vector 710 pointing from the current frame 700 to the generated frame 702 represents a motion vector which may be used with the generated frame 702 to predict the motion within one or more blocks of the current frame 700.

In particular, the reference frames 704 and 706 have already been coded by the time they are identified for use as reference frames for the current frame 700. As such, motion vectors of the reference frames 704 and 706 are already known and available, from the earlier coding of the reference frames 704 and 706. Thus, once the reference frames 704 and 706 are identified, a motion field is determined for the current frame 700 using the motion vectors of the reference frames 704 and 706. In particular, the motion field includes motion field motion vectors each pointing to one of the forward reference frame 706 or the backward reference frame 704. The motion field effectively represents how the motion field motion vectors can be projected to determine motion vectors for the current frame 700, since the current frame 700 is in between the backward reference frame 704 and the forward reference frame 706. In some cases, a compound motion vector derivation approach may be used.

The motion field determined for the current frame 700 using the motion vectors of the backward reference frame 704 and the forward reference frame 706 has a same size as the current frame 700. The motion field for the current frame 700 may be separately determined at each of an encoder and a decoder to reduce bitstream size otherwise used for signaling the motion field. Once the motion field has been determined, the motion field motion vectors of the motion field can be stored for later use. For example, the motion field motion vectors may be stored in a memory buffer or cache.

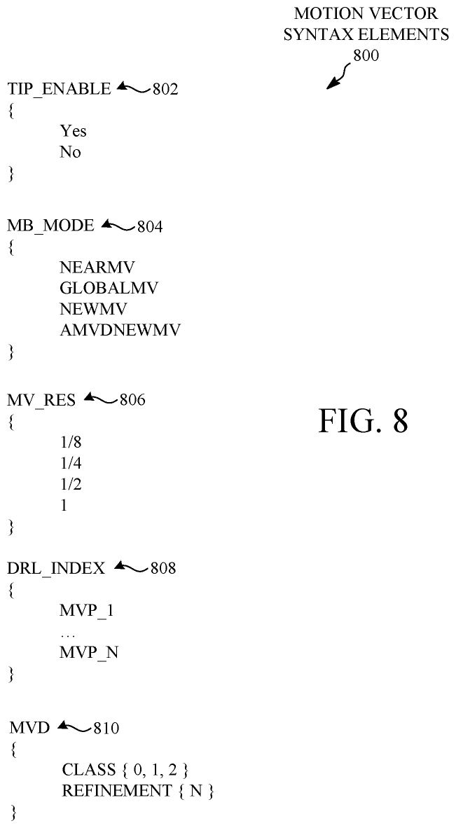

FIG. 8 is an illustration of signaled motion vector syntax elements 800 limited for TIP video coding. In particular, the motion vector syntax elements 800 are syntax elements which may be signaled within a frame header of a current frame to be encoded or decoded using the TIP mode described herein (e.g., the current frame 700). The motion vector syntax elements 800, as shown, include five sets of syntax elements, each of which may be signaled within a bitstream (e.g., the compressed bitstream 420) using one or more bits. A first set 802 corresponds to the syntax group TIP_ENABLE and includes two possible values: yes and no, in which yes indicates that TIP has been enabled and thus is to be used with the current frame and no indicates that TIP has not been enabled and thus is not to be used with the current frame. A second set 804 corresponds to the syntax group MB_MODE and includes four possible values: NEARMV, GLOBALMV, NEWMV, and AMVDNEWMV, representing the four possible motion vector modes which may be used with a motion vector (e.g., the motion vector 710) for the TIP mode prediction of the current frame. A third set 806 corresponds to the syntax group MV_RES and includes four possible values, expressed in units of pixels: ⅛, ¼, ½, and 1, representing the four possible pixel sizes (i.e., resolutions) to which the motion vector used for the TIP mode prediction of the current frame may correspond (i.e., given two neighboring pixels, where the motion vector will point on one of or between them). A fourth set 808 corresponds to the syntax group DRL_INDEX, describing a dynamic reference list, and includes N possible values, in which N is an integer greater than 1: as shown, 1 through N (e.g., 2), in which each of the values represents a different motion vector predictor candidate usable to predict the motion vector to use for the TIP mode prediction of the current frame (e.g., the temporal motion vector predictor 708). A fifth set 810 corresponds to the syntax group MVD, describing a motion vector difference, and includes two subsets of syntax information: class, indicating the class of the motion vector used for the TIP mode prediction of the current frame; and refinement, indicating an offset or other value to apply against that motion vector based at least in part on the class.

The motion vector syntax elements 800 are limited relative to the syntax elements which may be otherwise available for TIP mode prediction of the current frame. In particular, relative to current approaches which use TIP for video coding, the third set 806 is reduced to include only resolution values which are equal to or less than 1 pixel, the fourth set 808 is reduced to include a number of motion vector predictor candidates that is less than 4, and the fifth set 810 is reduced to include only classes 0, 1, and 2, and thus the corresponding refinements for only those three classes. These limitations are imposed because the relatively small size of the motion vector used for the TIP mode video coding (e.g., the motion vector 710) obviates motion vector resolutions larger than 1 pixel, large numbers of motion vector predictor candidates, and large classes. For example, because the motion vector is small, motion vector resolutions larger than 1 pixel would be inaccurate. In another example, because the motion vector is small, fewer motion vector predictor candidates are needed for evaluation, as it is more likely that one of two or three would accurately predict the motion vector. In yet another example, because the motion vector is small, the directional difference between the derived and refined versions of the motion vector (i.e., the motion vector before and after the refinement is applied, respectively) will be small enough to obviate larger classes. Because these specific limitations are by example, in some implementations, other limitations may be imposed upon one or more of the sets 802 through 810. In some cases, the fourth set 808 may be static (i.e., the same for all frames regardless of their contents or of other video information within or associated with the video stream which includes those frames) or dynamic (i.e., configurable, such as, by example, based on information associated with one or more neighbor frames).

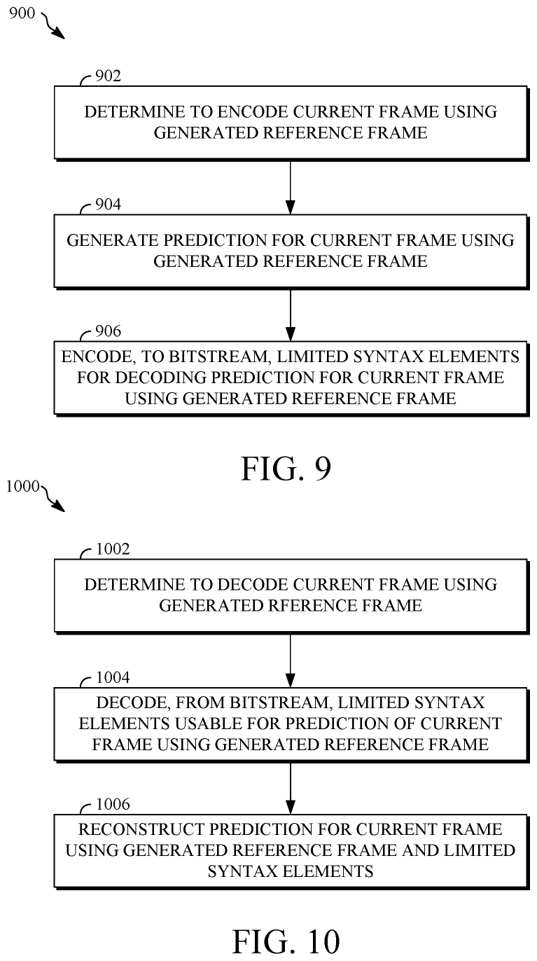

Further details of techniques for limiting signaled motion vector syntax for TIP video coding are now described. FIG. 9 is a flowchart diagram of an example of a technique 900 for encoding a current frame using temporally interpolated picture video coding with limited signaled motion vector syntax. FIG. 10 is a flowchart diagram of an example of a technique 1000 for decoding a current frame using temporally interpolated picture video coding with limited signaled motion vector syntax. For example, the technique 900 may be wholly or partially performed at a prediction stage of an encoder used to encode a video stream (e.g., the intra/inter prediction stage 402). Similarly, for example, the technique 1000 may be wholly or partially performed at a prediction stage of a decoder used to decode a bitstream (e.g., the intra/inter prediction stage 508).

The technique 900 and/or the technique 1000 can be implemented, for example, as a software program that may be executed by computing devices such as the transmitting station 102 or the receiving station 106. For example, the software program can include machine-readable instructions that may be stored in a memory such as the memory 204 or the secondary storage 214, and that, when executed by a processor, such as the processor 202, may cause the computing device to perform the technique 900 and/or the technique 1000.

The technique 900 and/or the technique 1000 can be implemented using specialized hardware or firmware. For example, a hardware component, such as a hardware coder, may be configured to perform the technique 900 and/or the technique 1000.

As explained above, some computing devices may have multiple memories or processors, and the operations described in the technique 900 and/or the technique 1000 can be distributed using multiple processors, memories, or both. For simplicity of explanation, the technique 900 and/or the technique 1000 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring first to FIG. 9, the technique 900 for encoding a current frame using temporally interpolated picture video coding with limited signaled motion vector syntax is shown. At 902, a determination is made to encode a current frame of a video stream using a generated reference frame (e.g., a TIP reference frame) generated using a backward reference frame of the current frame and a forward reference frame of the current frame. For example, the determination may be made based on the output of an encoder search performed against one or more frames of the video stream including the current frame. The output of the encoder search may, for example, indicate that an interpolation of a particular backward reference frame and a particular forward reference frame would yield a lowest rate distortion for an encoding of the current frame. The output of the encoder search may further indicate information usable for the TIP mode prediction of the current frame, for example, the motion vector mode, the motion vector resolution, the motion vector predictor, and the motion vector class and refinement to use for the TIP mode prediction of the current frame.

At 904, a prediction is generated for the current frame using the generated reference frame. Generating the prediction for the current frame includes performing motion compensation against the current frame using the generated reference frame as the reference frame and the motion vector determined using the encoder search. The prediction may be represented using a prediction residual, which may then, for example, be transformed, quantized, and entropy encoded to prepare same for encoding to a bitstream.

At 906, limited syntax elements usable for decoding the prediction for the current frame using the generated reference frame to a bitstream to which the prediction for the current frame is encoded. For example, the limited syntax elements may limit signaled motion vector resolution values for the prediction of the current frame during decoding to values less than or equal to 1. In another example, the limited syntax elements may limit a number of signaled motion vector predictors for use during decoding to less than 4. In yet another example, the limited syntax elements may limit signaled class information for a motion vector to use for the prediction for the current frame during decoding to class 0, class 1, or class 2.

Referring next to FIG. 10, the technique 1000 for decoding a current frame using temporally interpolated picture video coding with limited signaled motion vector syntax is shown. At 1002, a determination is made to decode a current frame of a video stream using a generated reference frame (e.g., a TIP reference frame) generated using a backward reference frame of the current frame and a forward reference frame of the current frame. For example, the determination may be made based on a syntax element (e.g., a one bit Boolean value) encoded within a bitstream from which the current frame is decoded. Data indicative of the particular backward reference frame and the particular forward reference frame to use to generate the generated reference frame are also decoded from the bitstream. For example, the syntax element indicating to use the TIP mode to predict the current frame and the data indicative of the backward and forward reference frames to use may all be encoded within a frame header of the current frame within the bitstream.

At 1004, limited syntax elements usable for a prediction of the current frame using the generated reference frame are decoded from the bitstream to which the prediction for the current frame is encoded. The limited syntax elements may, for example, represent the output of an encoder-side search performed during the encoding of the current frame. For example, the limited syntax elements may limit signaled motion vector resolution values for the prediction of the current frame during decoding to values less than or equal to 1. In another example, the limited syntax elements may limit a number of signaled motion vector predictors for use during decoding to less than 4. In yet another example, the limited syntax elements may limit signaled class information for a motion vector to use for the prediction for the current frame during decoding to class 0, class 1, or class 2.

At 1006, the prediction for the current frame is reconstructed using the generated reference frame and using the limited syntax elements. Reconstructing the prediction for the current frame includes performing motion compensation against the prediction for the current frame, represented, for example, as a prediction residual decoded from the bitstream, using the generated reference frame and the motion vector information corresponding to the limited syntax elements. The prediction residual may be added to a prediction block determined using the generated reference frame and the motion vector information to generate the reconstruction, which may then be filtered before it is output within an output video stream for storage or display.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof.

That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

Implementations of the transmitting station 102 and/or the receiving station 106 (and the algorithms, methods, instructions, etc., stored thereon and/or executed thereby, including by the encoder 400 and the decoder 500, or another encoder or decoder as disclosed herein) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102 can encode content into an encoded video signal and transmit the encoded video signal to the communications device. In turn, the communications device can then decode the encoded video signal. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device.

Further, all or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described implementations and other aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

1. A method for limiting signaled motion vector syntax for video coding, the method comprising:
determining to decode a current frame using a generated reference frame generated using a backward reference frame of the current frame and a forward reference frame of the current frame;
decoding, from a bitstream to which a prediction for the current frame is encoded, syntax elements usable for a prediction of the current frame using the generated reference frame, wherein the syntax elements limit one or more of signaled motion vector resolution values, signaled motion vector predictors, or signaled motion vector class information; and
reconstructing the prediction for the current frame using the generated reference frame and the syntax elements, wherein the determination to decode the current frame using the generated reference frame is based on a syntax element associated with the current frame within the bitstream.

2. The method of claim 1, wherein the syntax elements limit signaled motion vector resolution values for the prediction of the current frame to values less than or equal to 1.

3. The method of claim 1, wherein the syntax elements limit a number of signaled motion vector predictors to less than 4.

4. The method of claim 1, wherein the syntax elements limit signaled class information for a motion vector to use for the prediction for the current frame to class 0, class 1, or class 2.

5. The method of claim 1, wherein the syntax elements represent output of an encoder-side search performed during an encoding of the current frame.

6. The method of claim 1, wherein the syntax elements usable for a prediction of the current frame are signaled within a frame header of the current frame.

7. The method of claim 1, wherein the generated reference frame is a temporally interpolated picture reference frame.

8. A non-transitory computer readable medium having stored thereon an encoded bitstream, wherein the encoded bitstream is configured for decoding by operations for limiting signaled motion vector syntax for video coding, the operations comprising:
determining to decode a current frame using a generated reference frame associated with the current frame;
decoding, from the encoded bitstream, syntax elements limiting one or more of signaled motion vector resolution values, signaled motion vector predictors, or signaled motion vector class information; and
reconstructing a prediction for the current frame using the generated reference frame and the syntax elements, wherein the determination to decode the current frame using the generated reference frame is based on a syntax element associated with the current frame within the bitstream.

9. The non-transitory computer readable medium of claim 8, wherein the syntax elements limit signaled motion vector resolution values for the prediction of the current frame to values less than or equal to 1.

10. The non-transitory computer readable medium of claim 8, wherein the syntax elements limit a number of signaled motion vector predictors to less than 4.

11. The non-transitory computer readable medium of claim 8, wherein the syntax elements limit signaled class information for a motion vector to use for the prediction for the current frame to class 0, class 1, or class 2.

12. The non-transitory computer readable medium of claim 8, wherein the generated reference frame is a temporally interpolated picture reference frame generated using a backward reference frame of the current frame and a forward reference frame of the current frame.

13. An apparatus for limiting signaled motion vector syntax for video coding, the apparatus comprising:
a memory; and
a processor configured to execute instructions stored in the memory to:
decode, based on a determination to use a generated reference frame for a prediction of a current frame, syntax elements limiting one or more of signaled motion vector resolution values, signaled motion vector predictors, or signaled motion vector class information; and
reconstruct the prediction using the generated reference frame and the syntax elements, wherein the determination to decode the current frame using the generated reference frame is based on a syntax element associated with the current frame within a bitstream.

14. The apparatus of claim 13, wherein the syntax elements limit signaled motion vector resolution values for the prediction of the current frame to values less than or equal to 1.

15. The apparatus of claim 13, wherein the syntax elements limit a number of signaled motion vector predictors to less than 4.

16. The apparatus of claim 13, wherein the syntax elements limit signaled class information for a motion vector to use for the prediction for the current frame to class 0, class 1, or class 2.

17. The apparatus of claim 13, wherein the syntax elements represent output of an encoder-side search performed during an encoding of the current frame.

18. The apparatus of claim 13, wherein the generated reference frame is a temporally interpolated picture reference frame generated using a backward reference frame of the current frame and a forward reference frame of the current frame.
